(19) United States
(12) Patent Application Publication
(10) Pub. No.: US 2024/0365295 A1
(43) Pub. Date: Oct. 31, 2024

(54) METHODS AND DEVICES FOR SEMI-PERSISTENTLY SCHEDULED TRANSMISSION

(71) Applicant: Telefonaktiebolaget LM Ericsson (PUBL), Stockholm (SE)

(72) Inventors: Zhipeng Lin, NANJING Jiangsu (CN); Yufei Blankenship, KILDEER, IL (US)

(21) Appl. No.: 18/687,636

(22) PCT Filed: Sep. 2, 2022
(86) PCT No.: PCT/IB2022/058280

§ 371 Date: Feb. 28, 2024

(30) Foreign Application Priority Data
Sep. 3, 2021 (WO) PCT/CN2021/116484

(51) Int. Cl. H04W 72/0446; H04L 5/00; H04W 72/11

(52) U.S. Cl. CPC H04W 72/0446; H04L 5/0055; H04W 72/11

(57) ABSTRACT

According to some embodiments, a method is performed by a network node for semi-persistently scheduled transmission. pattern for multiple transport block (TB) transmission. The method comprises generating a time domain pattern information indicating a time domain pattern for a multiple transport block (TB) transmission. The method further comprises sending the time domain pattern information to a wireless device. The time domain pattern information may include a bitmap to indicate the time domain pattern for the semi-persistently scheduled data transmission. Each data transmission may occur periodically according to a previously 10 provided configuration.

### TECHNICAL FIELD

The present disclosure generally relates to communication networks, and more specifically to methods and devices for semi-persistently scheduled transmission.

### BACKGROUND

New Radio (NR) uses CP-OFDM (Cyclic Prefix Orthogonal Frequency Division Multiplexing) in both downlink (DL) (i.e., from a network node, gNB, or base station, to a user equipment or user equipment (UE)) and uplink (UL) (i.e., from UE to gNB). Discrete Fourier Transform (DFT) spread OFDM is also supported in the uplink. In the time domain, NR downlink and uplink are organized into equally sized subframes of 1 ms each. A subframe is further divided into multiple slots of equal duration. The slot length depends on subcarrier spacing. For subcarrier spacing of Δf=15 kHz, there is only one slot per subframe, and each slot consists of 14 OFDM symbols.

Data scheduling in NR is typically in slot basis, an example is illustrated in FIG. 1 with a 14-symbol slot, where the first two symbols contain physical downlink control channel (PDCCH) and the remaining symbols contain physical shared data channel, either PDSCH (physical downlink shared channel) or PUSCH (physical uplink shared channel).

Different subcarrier spacing values are supported in NR. The supported subcarrier spacing values (also referred to as different numerologies) are given by Δf=(15×2^{μ}) kHz where μ∈{0, 1,2,3,4}. Δf=15 kHz is the basic subcarrier spacing. The slot durations at different subcarrier spacings is given by ½ u ms.

In the frequency domain, a system bandwidth is divided into resource blocks (RBs), each corresponds to 12 contiguous subcarriers. The RBs are numbered starting with 0 from one end of the system bandwidth. The basic NR physical time-frequency resource grid is illustrated in

FIG. 2, where only one resource block (RB) within a 14-symbol slot is shown. One OFDM subcarrier during one OFDM symbol interval forms one resource element (RE).

### SUMMARY

Particular embodiments include a time domain transmission pattern for multiple codewords transmission on semi-persistent scheduled (SPS) PDSCH and in uplink configured grant based PUSCH in NR. For example, particular embodiments include: (a) time domain pattern determination and signaling; (b) hybrid automated retransmission request-acknowledgement (HARQ-ACK) transmission in response to SPS PDSCH transmissions with a configured time domain pattern; and (c) unit of bit map pattern, time domain resource allocation (TDRA) and multiple SPS/configured grant (CG) configurations when a bitmap pattern is configured for multiple TB transmissions.

According to some embodiments, a method is performed by a network node for semi-persistently scheduled transmission. The method comprises generating a time domain pattern information indicating a time domain pattern for a multiple transport block (TB) transmission. The method further comprises sending the time domain pattern information to a wireless device. In particular embodiments, the time domain pattern information may include a bitmap to indicate the time domain pattern for the semi-persistently scheduled data transmission. In particular embodiments, transmission time unit may be a slot, part of a slot or a number of slots.

In one example, one bit in the bitmap may correspond to one transmission time unit in the data transmission. In another example, the bitmap may have the same length as the period of the data transmission, where each bit in the bitmap corresponds to each transmission time unit in the period of the data transmission. In another example, the bitmap may be shorter than the period of the data transmission, where the bitmap of N_{bitmap} bits is applied to the first N_{bitmap} transmission time units in a given period, and no data transmission in the remaining transmission time units in the given period.

In particular embodiments, the time domain pattern information may include the period of the semi-persistent data transmission.

In particular embodiments, the multiple transport block transmission may be a semi-persistently scheduled data transmission, where each data transmission may occur periodically according to a previously provided configuration. In one example, the semi-persistently scheduled data transmission may be a semi-persistently scheduled data transmission in downlink. In another example, the semi-persistently scheduled data transmission may be a configured grant data transmission in uplink.

In particular embodiments, the data transmission may be transmitted with repetition, and the time domain pattern information may include the number of repetitions of the data transmission. In one example, the repetition may be performed for each data transmission in consecutive transmission time units. In another example, the repetition may be performed across different periods of the data transmission.

In particular embodiments, a HARQ-ACK may be generated by the wireless device and transmitted on the uplink in response to a downlink data transmission.

In particular embodiments, the time domain pattern information may include HARQ-ACK transmission parameters. The HARQ-ACK transmission parameters may include the timing of the HARQ-ACK transmission, the uplink resources for carrying the HARQ-ACK, the carrier for the HARQ-ACK transmission and/or the number of repetitions of the uplink for carrying the HARQ-ACK. In one example, one HARQ-ACK bit may be generated for each downlink data transmission individually. In another example, one HARQ-ACK bit may be generated for a group of downlink data transmissions. In another example, one HARQ-ACK bit may be generated for each downlink data transmission individually, including its repetitions. In another example, one HARQ-ACK bit may be generated for a group of downlink data transmissions including their repetitions.

According to some embodiments, a network node comprises processing circuitry operable to perform any of the network node methods described above.

According to some embodiments, a method is performed by a wireless device for semi-persistently scheduled transmission. The method comprises receiving a time domain pattern information indicating a time domain pattern for TB transmission. The method further comprises applying the time domain pattern information to a multiple TB transmission. In particular embodiments, the time domain pattern information may include a bitmap to indicate the time domain pattern for the semi-persistently scheduled data transmission. In particular embodiments, transmission time unit may be a slot, part of a slot or a number of slots.

In one example, one bit in the bitmap may correspond to one transmission time unit in the data transmission. In another example, the bitmap may have the same length as the period of the data transmission, where each bit in the bitmap corresponds to each transmission time unit in the period of the data transmission. In another example, the bitmap may be shorter than the period of the data transmission, where the bitmap of N_{bitmap} bits is applied to the first N_{bitmap} transmission time units in a given period, and no data transmission in the remaining transmission time units in the given period.

In particular embodiments, the time domain pattern information may include the period of the semi-persistent data transmission.

In particular embodiments, the multiple transport block transmission may be a semi-persistently scheduled data transmission, where each data transmission may occur periodically according to a previously provided configuration. In one example, the semi-persistently scheduled data transmission may be a semi-persistently scheduled data transmission in downlink. In another example, the semi-persistently scheduled data transmission may be a configured grant data transmission in uplink.

In particular embodiments, the data transmission may be transmitted with repetition, and the time domain pattern information may include the number of repetitions of the data transmission. In one example, the repetition may be performed for each data transmission in consecutive transmission time units. In another example, the repetition may be performed across different periods of the data transmission.

In particular embodiments, a HARQ-ACK may be generated by the wireless device and transmitted on the uplink in response to a downlink data transmission.

In particular embodiments, the time domain pattern information may include HARQ-ACK transmission parameters. The HARQ-ACK transmission parameters may include the timing of the HARQ-ACK transmission, the uplink resources for carrying the HARQ-ACK, the carrier for the HARQ-ACK transmission and/or the number of repetitions of the uplink for carrying the HARQ-ACK. In one example, one HARQ-ACK bit may be generated for each downlink data transmission individually. In another example, one HARQ-ACK bit may be generated for a group of downlink data transmissions. In another example, one HARQ-ACK bit may be generated for each downlink data transmission individually, including its repetitions. In another example, one HARQ-ACK bit may be generated for a group of downlink data transmissions including their repetitions.

According to some embodiments, a wireless device comprises processing circuitry operable to perform any of the wireless device methods described above.

Also disclosed is a computer program product comprising a non-transitory computer readable medium storing computer readable program code, the computer readable program code operable, when executed by processing circuitry to perform any of the methods performed by the wireless device described above.

Another computer program product comprises a non-transitory computer readable medium storing computer readable program code, the computer readable program code operable, when executed by processing circuitry to perform any of the methods performed by the network node described above.

Certain embodiments may provide one or more of the following technical advantages. For example, some embodiments provide methods for determining a time domain transmission pattern for multiple codewords transmission on SPS PDSCH and in uplink configured grant based PUSCH in NR.

### BRIEF DESCRIPTION OF THE DRAWINGS

The present disclosure may be best understood by way of example with reference to the following description and accompanying drawings that are used to illustrate embodiments of the present disclosure. In the drawings:

FIG. 1 is a diagram illustrating a NR time-domain structure with 15 kHz subcarrier spacing;

FIG. 2 illustrates a physical resource grid in a 5G NR network;

FIG. 3 provides an example of semi-persistent transmission pattern, where the periodicity=10 slots, and the bitmap for transmission pattern=[1 0 1 1 0 1 0 0 0 0];

FIG. 4 provides an example of semi-persistent transmission pattern, where the periodicity=10 slots, and the bitmap for transmission pattern=[1 0 0 1 1 0 0 0 0 0];

FIG. 5 provides an example of semi-persistent transmission pattern, where the periodicity=8 slots, and the bitmap for transmission pattern=[1 1 0 0 1 0 0 0];

FIG. 6 provides an example of semi-persistent transmission pattern for SPS PDSCH transmission with repetition within a period, where the periodicity=10 slots, the number of repetition for each SPS PDSCH=2, and the bitmap for transmission pattern=[1 0 1 1 0];

FIG. 7 provides an example of semi-persistent transmission pattern for SPS PDSCH transmission with repetition across periods, where the periodicity=10 slots, the number of repetitions for each SPS PDSCH=2, and the bitmap for transmission pattern=[1 0 0 0 1 0 1 0 0 0];

FIG. 8 provides an example of HARQ-ACK (i.e., ACK/NACK, or A/N) for SPS PDSCH transmission, where a HARQ-ACK is generated for each SPS PDSCH individually;

FIG. 9 provides an example of HARQ-ACK (i.e., ACK/NACK, or A/N) for SPS PDSCH transmission, where a HARQ-ACK is generated for a group of SPS PDSCH transmissions;

FIG. 10 provides an example of HARQ-ACK (i.e., ACK/NACK, or A/N) for SPS PDSCH transmission with repetition, where a HARQ-ACK is generated for each SPS PDSCH including its repetitions individually;

FIG. 11 provides an example of HARQ-ACK (i.e., ACK/NACK, or A/N) for SPS PDSCH transmission, where a HARQ-ACK is generated for a group of SPS PDSCH transmissions including repetitions;

FIG. 12 illustrates an example flow diagram for a method for semi-persistently scheduled transmission according to one or more embodiments of the present disclosure;

FIG. 13 illustrates an example flow diagram for a method for semi-persistently scheduled transmission according to one or more embodiments of the present disclosure;

FIG. 14 is a block diagram illustrating an example wireless network;

FIG. 15 illustrates an example user equipment, according to certain embodiments; and

FIG. 16 illustrates a schematic block diagram of a wireless device and network node in a wireless network, according to certain embodiments.

### DETAILED DESCRIPTION

In the embodiments and examples described herein, numerous specific details such as logic implementations, types and interrelationships of system components, etc. are set forth to provide a more thorough understanding of particular embodiments. It should be appreciated, however, that particular embodiments may be practiced without such specific details. In other examples, control structures, circuits and instruction sequences have not been shown in detail to avoid obscuring particular details

As used herein, the terms “first”, “second” and so forth refer to different elements. The singular forms “a”, “an”, and “the” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “according to” is to be read as “at least in part according to”. The term “one embodiment” and “an embodiment” are to be read as “at least one embodiment”. The term “another embodiment” is to be read as “at least one other embodiment”.

Unless otherwise defined, all terms (including technical and scientific terms) used herein have the same meanings as commonly understood. It will be further understood that a term used herein should be interpreted as having a meaning consistent with its meaning in the context of this specification and the relevant art and will not be interpreted in an idealized or overly formal sense unless expressly so defined herein.

Bracketed text and blocks with dashed borders (e.g., large dashes, small dashes, dot-dash, and dots) may be used herein to illustrate optional operations that add additional features to embodiments of the present disclosure. however, such notation should not be taken to mean that these are the only options or optional operations, and/or that blocks with solid borders are not optional in certain embodiments.

An electronic device stores and transmits (internally and/or with other electronic devices over a network) code (which is composed of software instructions and which is sometimes referred to as computer program code or a computer program) and/or data using machine-readable media (also referred to as computer-readable media), such as machine-readable storage media (e.g., magnetic disks, optical disks, read only memory (ROM), flash memory devices, phase change memory) and machine-readable transmission media (also referred to as a carrier) (e.g., electrical, optical, radio, acoustical or other form of propagated signals-such as carrier waves, infrared signals). Thus, an electronic device (e.g., a computer) includes hardware and software, such as a set of one or more processors coupled to one or more machine-readable storage media to store code for execution on the set of processors and/or to store data. For example, an electronic device may include non-volatile memory containing the code because the non-volatile memory can persist code/data even when the electronic device is turned off (when power is removed), and while the electronic device is turned on, that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of or one or more physical network interfaces to establish network connections (to transmit and/or receive code and/or data using propagating signals) with other electronic devices. One or more parts of an embodiment disclosed herein may be implemented using different combinations of software, firmware, and/or hardware.

As used herein, the term “DG PUSCH” refers to the dynamic grant scheduled PUSCH, and the term “CG PUSCH” refers to the PUSCH scheduled by configured grant.

As used herein, the term “DG PDSCH” refers to the dynamic grant scheduled PDSCH, and the term “SPS PDSCH” refers to the semi-persistently scheduled PDSCH.

In NR Rel-15, uplink data transmission can be dynamically scheduled using PDCCH. A UE first decodes uplink grants in PDCCH and then transmits data over PUSCH based the decoded control information in the uplink grant, such as modulation order, coding rate, uplink resource allocation, etc.

In contrast to dynamic scheduling of PUSCH, there is also a possibility to configure semi-persistent transmission of PUSCH using configured grants (CG), where each PUSCH is transmitted periodically without an accompanying PDCCH. There are two types of CG based PUSCH defined in NR Rel-15. In CG type 1, a periodicity of PUSCH transmission as well as the time domain offset are configured by resource radio control (RRC). In CG type 2, a periodicity of PUSCH transmission is configured by RRC and then the activation and release of such transmission is controlled by downlink control information (DCI), where the DCI is carried by a PDCCH.

NR also facilitates scheduling a PUSCH with time repetition by the RRC parameter pusch-AggregationFactor (for dynamically scheduled PUSCH) and repK (for PUSCH with uplink configured grant). In this case, the PUSCH is scheduled but transmitted in multiple adjacent slots (if the slot is available for uplink data transmission) up until the number of repetitions as determined by the configured RRC parameter.

For PUSCH with uplink configured grant, the redundancy version (RV) sequence to be used is configured by the repK-RV field when repetitions are used. If repetitions are not used for PUSCH with uplink configured grant, then the repK-RV field is absent.

NR Release-15 includes two mapping types, Type A and Type B, applicable to PDSCH and PUSCH transmissions. Type A is usually referred to as slot-based, while Type B transmissions may be referred to as non-slot-based or mini-slot-based.

Mini-slot transmissions may be dynamically scheduled. For NR Rel-15 a mini-slot transmission may be of length 7, 4, or 2 symbols for downlink, while it can be of any length for uplink. A mini-slot transmission may start and end in any symbol within a slot. Note that mini-slot transmissions in NR Rel-15 may not cross the slot border. One of two frequency hopping modes, inter-slot and intra-slot frequency hopping, may be configured via higher layer for PUSCH transmission in NR Rel-15, using information element (IE) PUSCH-Config for dynamic transmission or IE configuredGrantConfig for type 1 and type2 configured grant (CG).

In downlink, the gNB may dynamically allocate resources to UEs via the DCI carried on PDCCH(s), where the PDCCH is marked with the UE ID (e.g., cell-radio network temporary identifier (C-RNTI), modulation and coding scheme C-RNTI (MCS-C-RNTI), configured scheduling RNTI (CS-RNTI). In particular, the UE ID CS-RNTI indicates semi-persistently scheduled data, either downlink data transmission (i.e., DL SPS PDSCH) or uplink data transmission (i.e., UL CG PUSCH). A UE always monitors the PDCCH(s) to find possible assignments when its downlink reception is enabled (activity governed by discontinuous reception (DRX) when configured). When carrier aggregation (CA) is configured, the same C-RNTI applies to all serving cells.

A gNB may preempt an ongoing PDSCH transmission to one UE with a latency-critical transmission to another UE. The gNB may configure UEs to monitor interrupted transmission indications using INT-RNTI on a PDCCH. If a UE receives the interrupted transmission indication, the UE may assume that no useful information to that UE was carried by the resource elements included in the indication, even if some of the resource elements were already scheduled to the UE.

In addition, with downlink semi-persistent scheduling (SPS), the gNB can allocate periodically recurring downlink resources for the initial transmissions of downlink data packets to UEs. RRC defines the periodicity of the configured downlink assignments, while PDCCH addressed to CS-RNTI can either signal and activate the configured downlink assignment, or deactivate it, i.e., an activation PDCCH addressed to CS-RNTI indicates that the downlink assignment can be implicitly reused according to the periodicity defined by RRC, until deactivated by a deactivation DCI.

When required, for downlink semi-persistently scheduled (DL SPS) data packets, hybrid automated retransmission request (HARQ) retransmissions of the failed initial transmission are explicitly scheduled via PDCCH(s). That is, retransmissions use dynamically scheduled PDSCH, rather than the semi-persistently scheduled DL SPS PDSCH.

The dynamically allocated downlink reception overrides the semi-persistently scheduled downlink assignment in the same serving cell if they overlap in time. Otherwise (i.e., no dynamically scheduled data that overlaps with DL SPS PDSCH) a downlink reception according to the configured downlink assignment is assumed, if the DL SPS configuration is activated.

The UE may be configured with up to 8 DL SPS configurations simultaneously for a given bandwidth part (BWP) of a serving cell. When more than one is configured, the network decides which of the DL SPS configurations are active at the same time (including all of them). Each DL SPS configuration is activated separately using a DCI command, and deactivation of DL SPS configuration is done using a DCI command, which can either deactivate a single DL SPS configuration or multiple DL SPS configurations jointly.

With uplink configured grants (UL CG), the gNB can allocate periodically recurring uplink resources for the initial transmissions of uplink data packets to UEs. When required, for UL CG data packets, HARQ retransmissions of the failed initial transmission are explicitly scheduled via PDCCH(s). That is, retransmissions use dynamically scheduled PUSCH, rather than the semi-persistently scheduled UL CG PUSCH.

Two types of configured uplink grants are defined. For Type 1, RRC directly provides the configuration parameters for the configured uplink grant (including the periodicity). For Type 2, RRC defines some of the configuration parameters including the periodicity of the configured uplink grant while the activation DCI (carried by a PDCCH addressed to CS-RNTI) can activate the UL CG configuration and provide the remaining configuration parameters (e.g., modulation and coding rate, time domain resources, frequency domain resources). The PDCCH addressed to the UE's CS-RNTI can either signal and activate the configured uplink grant, or deactivate it. A PDCCH (which carries the activation DCI) addressed to CS-RNTI indicates that the uplink grant can be implicitly reused according to the periodicity defined by RRC, until deactivated by another PDCCH (which carries the deactivation DCI) addressed to the CS-RNTI.

NR Release 16 includes PUSCH repetition enhancements for both PUSCH type A and type B for further latency reduction (i.e., for Rel-16 ultra-reliable low-latency communications (URLLC) feature).

In NR Rel-15, the number of aggregated slots for both dynamic grant and configured grant Type 2 are RRC configured. In NR Rel-16, this was enhanced where the number of repetitions can be dynamically indicated, i.e., the number of repetitions can be changed from one PUSCH scheduling occasion to the next via DCI indication. That is, in addition to the starting symbol S, and the length of the PUSCH L, a number of nominal repetitions K is signaled as part of time-domain resource allocation (TDRA).

Furthermore, the maximum number of aggregated slots was increased to K=16 to account for downlink heavy time division duplex (TDD) patterns. Inter-slot and intra-slot hopping can be applied for PUSCH repetition Type A. The number of repetitions K is nominal because some slots may be downlink slots and the downlink slots are then skipped for PUSCH transmissions. Thus, K is the maximal number of repetitions possible.

PUSCH repetition Type B applies to both dynamic and configured grants. Type B PUSCH repetition can cross the slot boundary in NR Rel-16. When scheduling a transmission with PUSCH repetition Type B, in addition to the starting symbol S, and the length of the PUSCH L, a number of nominal repetitions K is signaled as part of time-domain resource allocation (TDRA). Inter-slot frequency hopping and inter-repetition frequency hopping can be configured for Type B repetition. Determining the actual time domain allocation of Type B PUSCH repetitions is a two-step process. First, allocate K nominal repetitions of length L back-to-back (adjacent in time), ignoring slot boundaries and TDD pattern. Then, if a nominal repetition crosses a slot boundary or occupies symbols not usable for uplink transmission (e.g., UL/DL switching points due to TDD pattern), the offending nominal repetition may be split into two or more shorter actual repetitions. If the number of potentially valid symbols for PUSCH repetition type B transmission is greater than zero for a nominal repetition, the nominal repetition consists of one or more actual repetitions, where each actual repetition consists of a consecutive set of potentially valid symbols that can be used for PUSCH repetition Type B transmission within a slot.

Although the term ‘PUSCH repetition’ is used herein, it may be interchangeably used with other terms such as ‘PUSCH transmission occasion’.

In NR Rel-15/16, when PUSCH is repeated according to PUSCH repetition Type A, the PUSCH is limited to a single transmission layer.

Rel-15 includes slot aggregation, also known as PUSCH repetition Type A in Rel-16, where a number of slot-based PUSCH repetitions is semi-statically configured. In Rel-16, the number of PUSCH repetitions can be dynamically indicated with DCI.

In Rel-15/16, PUSCH repetition Type A allows a single repetition in each slot, with each repetition occupying the same symbols. Some TDD UL/DL configurations may include a small number of contiguous UL slots in a radio frame. In this scenario, multiple PUSCH repetitions do not have to be in contiguous slots. However, the downlink slots are counted as slots for PUSCH repetitions.

Rel-17 includes two enhancements for PUSCH repetition Type A. For PUSCH repetition Type A, a first option includes increasing the maximum number of repetitions. In a second option, the number of repetitions are determined based on available uplink slots.

Regarding option 2, in general, available uplink slots refers to uplink slots that are available for the given PUSCH transmission, for example, not allocated for downlink transmission; not being pre-occupied by another uplink transmission; not limited by device implementation, etc.

For downlink, available downlink slots refer to downlink slots that are available for the given PDSCH transmission, for example, not allocated for uplink transmission; not being pre-occupied by another downlink transmission (e.g., downlink broadcast messages and associated PDCCH); not limited by circuit implementation, etc.

In NR semi-persistent scheduling (either DL SPS PDSCH transmission, or UL CG PUSCH transmission), up to Rel-18, one data transmission is transmitted in one period. If configured, the data transmission can be repeated in consecutive slots (or consecutive, available slots). This is inadequate for higher throughput traffic with periodic, or semi-periodic data arrival.

Particular embodiments include methods on time domain transmission patterns for multiple codewords transmission on DL SPS PDSCH and in UL configured grant based PUSCH in NR. For example, particular embodiments include time domain pattern determination and signaling, HARQ-ACK (HARQ acknowledgement) transmission in response to SPS PDSCH transmissions with a configured time domain pattern, unit of bit map pattern, TDRA, and multiple SPS and/or CG configurations when a bitmap pattern is configured for multiple transport block (TB) transmissions for a given SPS and/or CG configuration.

In some embodiments, a bitmap indicates the time domain pattern for multiple transport block transmission. The bitmap may be used for semi-persistently scheduled data transmission, where each data transmission occurs periodically according to previously provided configuration without an associated downlink control information (DCI).

The configuration may be provided by RRC configuration, and optionally, with additional configuration information provided in the activation DCI. After a semi-persistently scheduled configuration is activated, the data transmission occurs periodically until the configuration is deactivated. For downlink, one configuration of the semi-persistently scheduled transmission is referred to as a downlink semi-persistently scheduled (SPS) configuration. For uplink, one configuration of the semi-persistently scheduled transmission is referred to as an uplink configured grant (CG) configuration.

For example, bit ‘1’ in the bitmap indicates that data will be transmitted in the indicated TTI (transmission time interval), whereas bit ‘0’ in the bitmap indicates that no data will be transmitted in the indicated TTI. A typical example of TTI is a slot in NR. Data refers to downlink data for DL SPS, and refers to uplink data for UL CG. For one DL SPS PDSCH (or one UL CG PUSCH), the data may be in the format of one or two codewords, depending on the number of multiple input multiple output (MIMO) layers used. Without losing generality, the description below assumes one TB (i.e., one codeword, one codeword carrying one TB) is carried by one DL SPS PDSCH (or one UL CG PUSCH). It is understood that the same methodology may be applied where two or more TBs (i.e., two or more codewords, one codeword carrying one TB) are carried by one DL SPS PDSCH (or one UL CG PUSCH).

In some embodiments, the bitmap has the same length as the period, where each bit in the bitmap of N_{bitmap} bits corresponds to each slot in the period of Nₚ slots. For example, if the period has duration of Nₚ=0 slots, then the bitmap is composed of N_{bitmap}=10 bits, with one bit for one slot within a period. Alternatively, the bitmap can be shorter than the period, where the bitmap of N_{bitmap} bits is applied to the first N_{bitmap} slots in a given period, and no data transmission in the remaining (Nₚ-N_{bitmap}) slots in the given period. For instances, if the period has duration of Nₚ=10 slots, and the bitmap is composed of N_{bitmap}=4 bits, then the bitmap provides the transmission time instances in the first 4 slots within a period, and no data transmission in the remaining 6 slots.

In some embodiments, a periodicity of length P (unit: TTI) is configured or predetermined. Within one periodicity, a bitmap designates the transmission timing of a set of multiple data transmission instances, where one data transmission carries one TB.

For downlink, the data transmission is a PDSCH, and can be further categorized as semi-persistently scheduled (SPS) PDSCH where the set of multiple PDSCH transmissions occur periodically after the SPS configuration is activated. Typically, a SPS configuration is activated by a DCI. For uplink, the data transmission is a PUSCH, and can be further categorized as uplink configured grant (CG) PUSCH where the PUSCH transmissions occur periodically after the CG configuration is activated. Typically, an UL CG configuration is activated by a DCI.

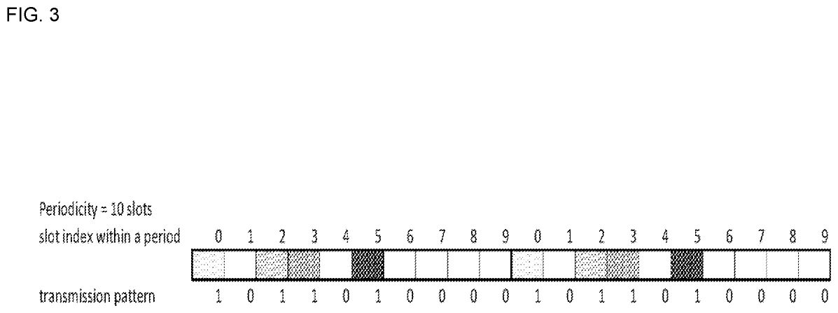

FIG. 3 provides an example of semi-persistent transmission pattern, where the periodicity=10 slots, and the bitmap for transmission pattern=[1 0 1 1 0 1 0 0 0 0]. In FIG. 3, the bitmap indicates that for each period, four TTIs have data transmissions, with each TTI occupied by a different TB. That is, in one period of 10 slots, 4 TBs are semi-persistently scheduled for transmission, with transmission timing arranged according to the bitmap [1 0 1 1 0 1 0 0 0 0]. In FIG. 3, in a given period, boxes of different shading patterns indicate that different TBs are transmitted in different time instances. Between different periods, the bitmap is shown to repeat. It is understood that different TBs are transmitted in different periods even though the same shading pattern is used between two periods.

As the traffic timing changes, correspondingly, different bitmaps may be indicated to adapt the TB transmission timing to the traffic needs.

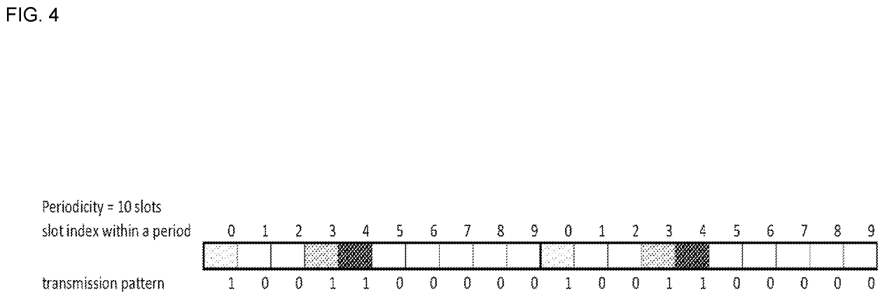

FIG. 4 provides an example of semi-persistent transmission pattern, where the periodicity=10 slots, and the bitmap for transmission pattern=[1 0 0 1 1 0 0 0 0 0]. In FIG. 4, the bitmap indicates that three different TBs are transmitted within one period of 10 slots, with transmission timing arranged according to the bitmap [1 0 0 1 1 0 0 0 0 0]. Thus, the scheduler may adapt the data transmission from FIG. 3 to FIG. 4, by indicating a bitmap change. The bitmap change may be signaled by RRC message (i.e., semi-statically change the bitmap) or by DCI (i.e., dynamically change the bitmap).

When the traffic timing changes, in general, both new periodicity and new bitmap may be indicated to adapt the TB transmission timing to the traffic needs.

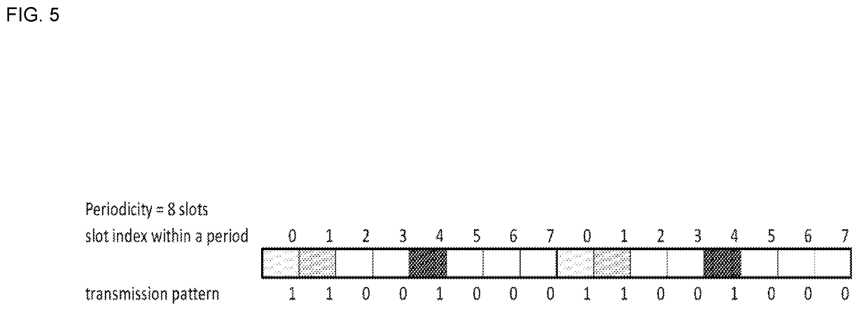

FIG. 5 provides an example of semi-persistent transmission pattern, where the periodicity=8 slots, and the bitmap for transmission pattern= [1 1 0 0 1 0 0 0]. In FIG. 5, the bitmap indicates that three different TBs are transmitted within one period of 8 slots, with transmission timing arranged according to the bitmap [1 1 0 0 1 0 0 0]. Thus, the scheduler may adapt the data transmission from FIG. 3 to FIG. 5 by indicating a periodicity change and a bitmap change. The periodicity change and bitmap change may be signaled by RRC message (i.e., semi-static configuration update) or by DCI (i.e., dynamic configuration update).

In some embodiments, to achieve high reliability of data transmission, one data transmission may be transmitted with repetition. The data transmission may be DL SPS PDSCH transmission, or UL CG PUSCH transmission.

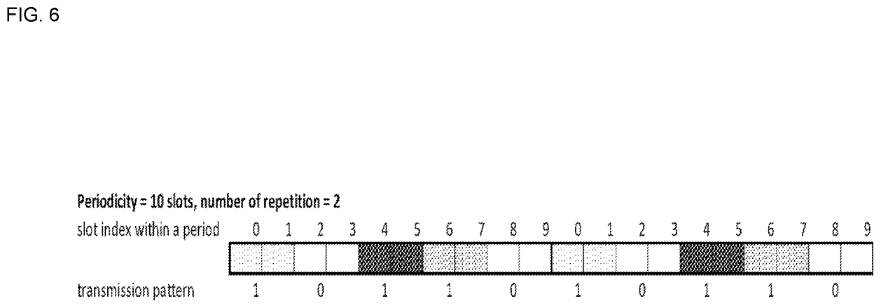

FIG. 6 provides an example of semi-persistent transmission pattern for SPS PDSCH transmission with repetition within a period, where the periodicity=10 slots, the number of repetition for each SPS PDSCH=2, and the bitmap for transmission pattern=[1 0 1 1 0]. As shown in FIG. 6, the repetition is performed for each data transmission consecutively. Denote the number of repetitions of data transmission as Nᵣₑₚ. Then for each data transmission designated by the bitmap, it is repeated Nᵣₑₚ times consecutively. It can be equivalently understood that each bit in the bitmap is repeated Nᵣₑₚ times to form an expanded bitmap, where the expanded bitmap indicates occupation of data transmission. This can be illustrated by the example in FIG. 6, where the bitmap=[1 0 1 1 0] and Nᵣₑₚ=2. Within a period, boxes of different shading patterns indicate that different data (i.e., TBs) are transmitted, and boxes of a given shading pattern are repeated to indicate that the data transmission is repeated. It is understood that different TBs are transmitted in different periods even though the same shading pattern is used between two periods.

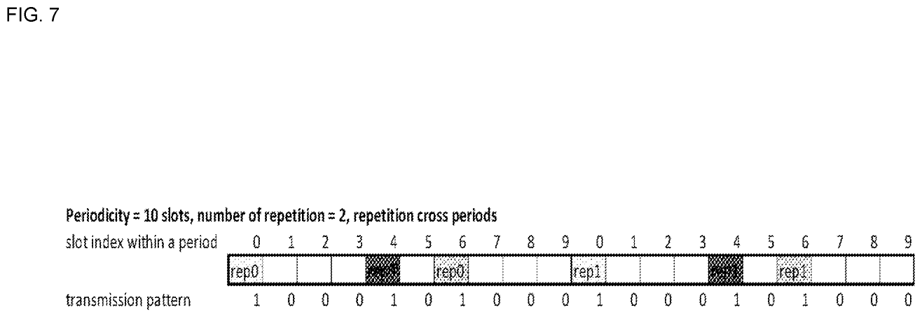

FIG. 7 provides an example of semi-persistent transmission pattern for SPS PDSCH transmission with repetition across periods, where the periodicity=10 slots, the number of repetitions for each SPS PDSCH=2, and the bitmap for transmission pattern=[1 0 0 0 1 0 1 0 0 0]. As shown in FIG. 7, the repetition is performed across different periods of the bitmap. In FIG. 7, Nᵣₑₚ=2 is realized across two adjacent periods. ‘rep0’ and ‘rep1’ of a given shading pattern indicate that the same data packet (i.e., TB) is sent twice.

In some embodiments, one or more of the transmission parameter(s) are provided by RRC configuration for a given semi-persistent configuration. The semi-persistent configuration may be DL SPS for downlink data or UL CG for uplink data. For DL SPS and UL CG, each is provided its transmission parameters separately.

The transmission parameter(s) of a configuration may include: (a) the periodicity of the configuration, Nₚ; (b) the TTI bitmap; (c) the number of repetitions of a data packet, Nᵣₑₚ; and (d) the HARQ-ACK transmission parameter(s), where the HARQ-ACK is in response to the PDSCH transmission, if the data transmission is a PDSCH transmission. The HARQ-ACK transmission parameter(s) may include: (a) the timing of the HARQ-ACK transmission, (b) the PUCCH time/frequency resources for carrying the HARQ-ACK; (c) the carrier for the HARQ-ACK transmission; (d) the number of repetitions of the PUCCH for carrying the HARQ-ACK; (e) the priority level of the HARQ-ACK.

In some embodiments, one or more of the transmission parameter(s) is provided by the MAC CE (medium access control control element).

For example, a list of N₀ possible bitmaps are provided via RRC signalling for a given periodicity. Then a subset of N₁ bitmaps are short-listed by the MAC CE, 1≤N₁≤N₀. The actually used bitmap is then selected from the N₁ bitmaps.

In some embodiments, one or more of the transmission parameter(s) is provided by the activation DCI. Typically, the DCI are: DCI format 1_0/1_1/1_2 for DL SPS, and DCI format 0_0/0_1/0_2 for UL CG.

For example, the TTI bitmap can be indicated by an explicit DCI field, or it can be implicitly provided by entries in the TDRA (time domain resource allocation) table signaled by the DCI.

Corresponding to the TB(s) carried in a DL SPS PDSCH transmission, HARQ-ACK is to be generated by the UE and transmitted on the uplink.

For UL CG, no HARQ-ACK is transmitted in NR, although it is possible that HARQ-ACK is generated and transmitted for UL CG PUSCH, similar to that of DL SPS.

The description below assumes that HARQ-ACK is generated for DL SPS PDSCH, and transmitted on the uplink, without losing generality.

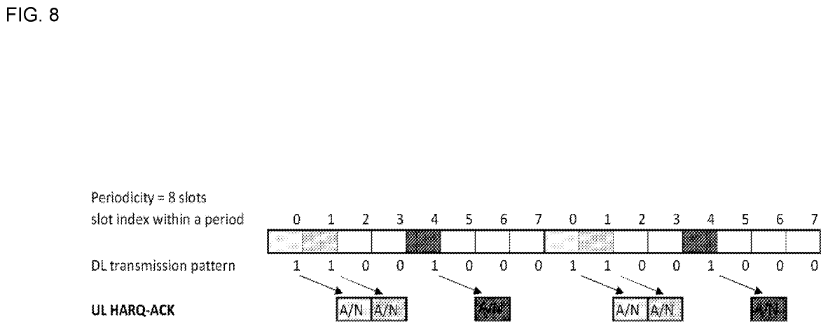

FIG. 8 provides an example of HARQ-ACK (i.e., ACK/NACK (acknowledged/not acknowledged), or A/N) for SPS PDSCH transmission. A HARQ-ACK is generated for each SPS PDSCH individually. As shown in FIG. 8, one HARQ-ACK bit is generated for each SPS PDSCH transmission individually. In this example, ACK/NACK (labeled as A/N) of a given shading pattern is generated for a PDSCH of the same shading pattern, indicating that the ACK/NACK is in response to the corresponding PDSCH, where ACK indicates a successful reception of the PDSCH, and NACK indicates a failed reception of the PDSCH. This example assumes that HARQ-ACK (i.e., ACK/NACK) timing is two slots after the corresponding PDSCH, although other value can be assumed as HARQ-ACK response time.

Note that, for simplicity, it is assumed that an uplink slot has the same duration as a downlink slot, i.e., uplink and downlink use the same SCS (subcarrier spacing). In general, uplink slot may have the same, or different, duration as a downlink slot, i.e., uplink and downlink may use the same, or different, SCS (subcarrier spacing). It is understood that particular embodiments apply either way, with minor adjustment if the uplink slot does not have the same duration as the downlink slot.

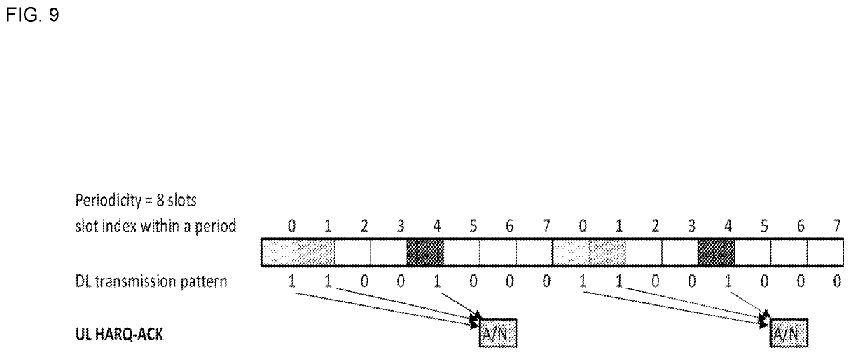

FIG. 9 provides an example of HARQ-ACK (i.e., ACK/NACK, or A/N) for SPS PDSCH transmission. A HARQ-ACK is generated for a group of SPS PDSCH transmissions.

As shown in FIG. 9, one HARQ-ACK bit is generated for a group of SPS PDSCH transmissions. This has the benefit of reducing HARQ-ACK transmission burden. In this example, the group of SPS PDSCH refers to the multiple SPS PDSCH allocated by one bitmap in a period. Thus ACK/NACK bundling is applied across the group of PDSCHs. For example, as long as one of the SPS PDSCH within the group of SPS PDSCH transmissions is not correctly decoded, a NACK will be reported. An ACK is reported if all PDSCHs in the group are correctly received.

In general, the grouping of PDSCH for ACK/NACK bundling may or may not be closely tied to the bitmap. For example, the ACK/NACK bundling can be applied to every N_{bundle} consecutive PDSCHs. N_{bundle} can take integer values like N_{bundle}=2, or 4.

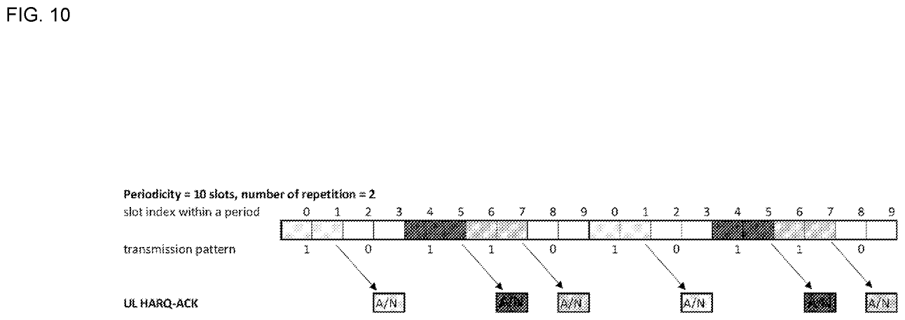

FIG. 10 provides an example of HARQ-ACK (i.e., ACK/NACK, or A/N) for SPS PDSCH transmission with repetition. A HARQ-ACK is generated for each SPS PDSCH (including its repetitions) individually.

As shown in FIG. 10, one HARQ-ACK bit is generated for each SPS PDSCH transmission individually, where a SPS PDSCH transmission may include its repetitions. In this example, one PDSCH transmission is repeated with Nᵣₑₚ=2. One A/N is generated for each PDSCH, and the HARQ-ACK timing for a given PDSCH is measured from the last repetition of this PDSCH. In this example, HARQ-ACK is reported two slots after the PDSCH transmission, as measured from the last repetition of the given PDSCH.

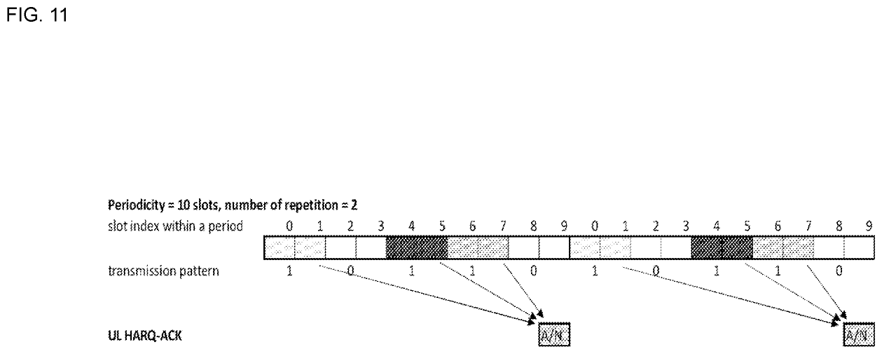

FIG. 11 provides an example of HARQ-ACK (i.e., ACK/NACK, or A/N) for SPS PDSCH transmission. An HARQ-ACK is generated for a group of SPS PDSCH transmissions including repetitions.

As shown in FIG. 11, one HARQ-ACK bit is generated for a group of SPS PDSCH transmissions including their repetitions. This has the benefit of reducing HARQ-ACK transmission burden. In this example, the group of SPS PDSCH refers to the multiple SPS PDSCH allocated by one bitmap. As long as one of the SPS PDSCH within the group of SPS PDSCH transmissions is not correctly decoded, a NACK will be reported. An ACK is reported if all PDSCHs in the group are correctly received.

In general, the grouping of PDSCH for ACK/NACK bundling may or may not be closely tied to the bitmap. For example, the ACK/NACK bundling can be applied to every N_{bundle} consecutive PDSCHs, where a given PDSCH may be repeated Nᵣₑₚ times. N_{bundle} can take integer values like N_{bundle}=2, or 4.

In the description above, the unit of bit map pattern is a slot, i.e., each bit of the bitmap refers to a slot. In general, time units other than a slot can be used. For example:
a) Time unit=half of a slot, which equals 7 symbols for NR numerology of normal cyclic prefix, and equals to 6 symbols for NR numerology of extended cyclic prefix.
b) Time unit=mini-slot, where the mini-slot is configured to be Y symbols. Typical values of Y may be Y=2, or 3, or 4 symbols in NR.
c) Time unit=an integer number (Z) slots. For example, Z=4 slots may be aggregated, and one TB is mapped across Z slots for transmission.

Thus, in some embodiments, the unit or TTI of the bitmap pattern can be a slot, part of a slot or a number of slots. It is understood that the time unit or TTI should be understood in general terms, even though for simplicity of description the unit is often assumed to be a slot.

In the description above, it is understood that the time domain resource allocated for the DL SPS PDSCH is provided in addition to the slot-level bitmap. Similarly, for UL CG, the time domain resource allocation (TDRA) information is provided in addition to the slot-level bitmap.

In some embodiments, the TDRA information is provided in addition to the slot-level bitmap.

Although the description above may be focused on an individual semi-persistent configuration, either a DL SPS configuration, or an UL configured grant (CG) configuration, in general, for both DL and UL, multiple semi-persistent configurations may be configured, and/or activated, simultaneously.

In some embodiments, multiple DL SPS configurations, and/or multiple CG configurations, may be configured, and/or activated, simultaneously.

The description above, for simplicity, assumes that all slots are available for data transmission. In an actual system, this may not be true. For example, slot(s) may not be available due to TDD uplink/downlink pattern, due to conflict with another transmission or reception, or due to implementation constraints (e.g., uplink-to-downlink transition time, or downlink-to-uplink transition time). In this case, the data transmission time adjusts according to the availability of the slots.

For example, when a slot is not available, the planned data transmission for that slot may be dropped. Alternatively, the planned data transmission for a given slot (which is unavailable for transmission) may be delayed to the next available slot without being dropped, i.e., the planned data transmission pattern is mapped to available slots by skipping over the unavailable slots.

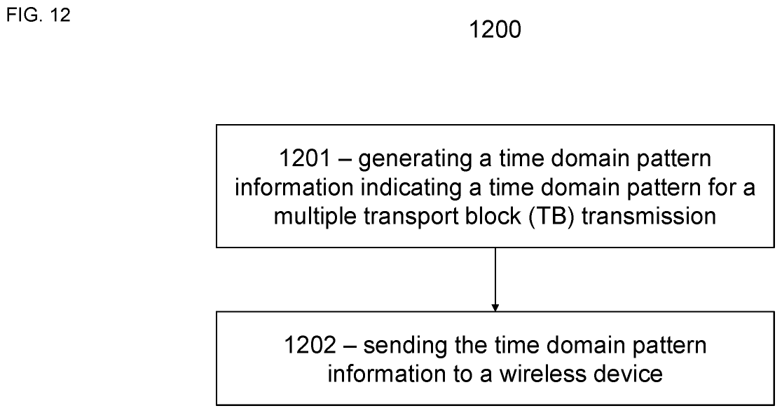

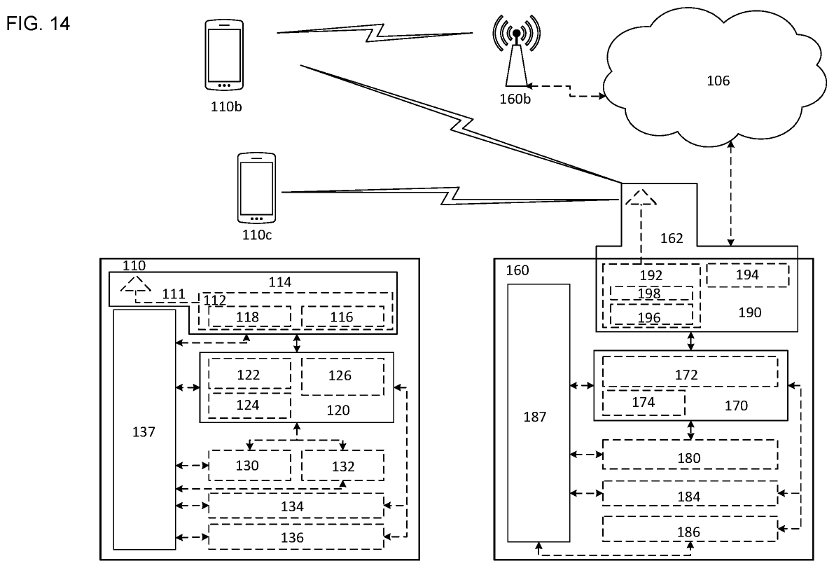

FIG. 12 illustrates an example flow diagram for a method 1200 for semi-persistently scheduled transmission according to one or more embodiments of the present disclosure. In particular embodiments, one or more steps of method 1200 may be performed by wireless device 110 and/or network node 160 described with respect to FIG. 14.

The method 1200 may begin at step 1201, where the wireless receiver (e.g., wireless device 110 or network node 160) generates a time domain pattern information indicating a time domain pattern for a multiple TB transmission. According to the embodiments and examples described herein, the time domain pattern information may include a bitmap to indicate the time domain pattern for the semi-persistently scheduled data transmission. According to the embodiments and examples described herein, transmission time unit may be a slot, part of a slot or a number of slots.

In one example, one bit in the bitmap may correspond to one transmission time unit in the data transmission. In another example, the bitmap may have the same length as the period of the data transmission, where each bit in the bitmap corresponds to each transmission time unit in the period of the data transmission. In another example, the bitmap may be shorter than the period of the data transmission, where the bitmap of N_{bitmap} bits is applied to the first N_{bitmap} transmission time units in a given period, and no data transmission in the remaining transmission time units in the given period.

According to the embodiments and examples described herein, the time domain pattern information may include the period of the semi-persistent data transmission.

At step 1202, the wireless receiver sends the time domain pattern information to a wireless device (e.g., wireless device 110 or network node 160).

According to the embodiments and examples described herein, the multiple transport block transmission may be a semi-persistently scheduled data transmission, where each data transmission may occur periodically according to a previously provided configuration. In one example, the semi-persistently scheduled data transmission may be a semi-persistently scheduled data transmission in downlink. In another example, the semi-persistently scheduled data transmission may be a configured grant data transmission in uplink.

According to the embodiments and examples described herein, the data transmission may be transmitted with repetition, and the time domain pattern information may include the number of repetitions of the data transmission. In one example, the repetition may be performed for each data transmission in consecutive transmission time units. In another example, the repetition may be performed across different periods of the data transmission.

According to the embodiments and examples described herein, a HARQ-ACK may be generated by the wireless device and transmitted on the uplink in response to a downlink data transmission.

According to the embodiments and examples described herein, the time domain pattern information may include HARQ-ACK transmission parameters. The HARQ-ACK transmission parameters may include the timing of the HARQ-ACK transmission, the uplink resources for carrying the HARQ-ACK, the carrier for the HARQ-ACK transmission and/or the number of repetitions of the uplink for carrying the HARQ-ACK. In one example, one HARQ-ACK bit may be generated for each downlink data transmission individually. In another example, one HARQ-ACK bit may be generated for a group of downlink data transmissions. In another example, one HARQ-ACK bit may be generated for each downlink data transmission individually, including its repetitions. In another example, one HARQ-ACK bit may be generated for a group of downlink data transmissions including their repetitions.

Modifications, additions, or omissions may be made to the method of FIG. 12. Additionally, one or more steps in the method of FIG. 12 may be performed in parallel or in any suitable order.

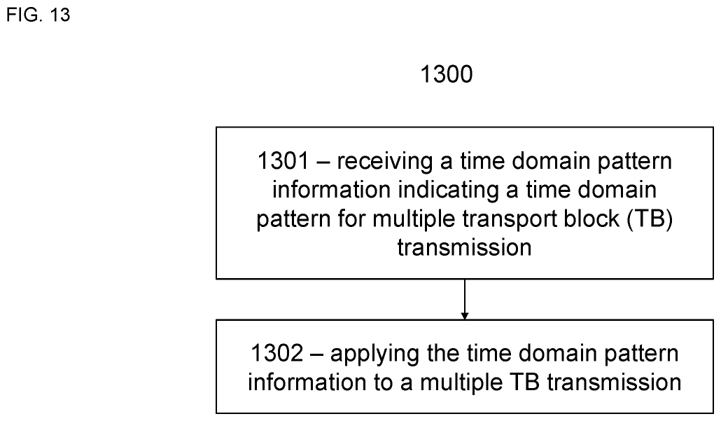

FIG. 13 illustrates an example flow diagram for a method 1300 for semi-persistently scheduled transmission according to one or more embodiments of the present disclosure. In particular embodiments, one or more steps of method 1300 may be performed by wireless device 110 and/or network node 160 described with respect to FIG. 14.

The method 1300 may begin at step 1301, where the wireless receiver (e.g., wireless device 110 or network node 160) receives a time domain pattern information indicating a time domain pattern for multiple TB transmission. According to the embodiments and examples described herein, the time domain pattern information may include a bitmap to indicate the time domain pattern for the semi-persistently scheduled data transmission. According to the embodiments and examples described herein, transmission time unit may be a slot, part of a slot or a number of slots.

In one example, one bit in the bitmap may correspond to one transmission time unit in the data transmission. In another example, the bitmap may have the same length as the period of the data transmission, where each bit in the bitmap corresponds to each transmission time unit in the period of the data transmission. In another example, the bitmap may be shorter than the period of the data transmission, where the bitmap of N_{bitmap} bits is applied to the first N_{bitmap} transmission time units in a given period, and no data transmission in the remaining transmission time units in the given period.

According to the embodiments and examples described herein, the time domain pattern information may include the period of the semi-persistent data transmission.

At step 1202, the wireless receiver sends the time domain pattern information to a wireless device (e.g., wireless device 110 or network node 160).

According to the embodiments and examples described herein, the multiple transport block transmission may be a semi-persistently scheduled data transmission, where each data transmission may occur periodically according to a previously provided configuration. In one example, the semi-persistently scheduled data transmission may be a semi-persistently scheduled data transmission in downlink. In another example, the semi-persistently scheduled data transmission may be a configured grant data transmission in uplink.

According to the embodiments and examples described herein, the data transmission may be transmitted with repetition, and the time domain pattern information may include the number of repetitions of the data transmission. In one example, the repetition may be performed for each data transmission in consecutive transmission time units. In another example, the repetition may be performed across different periods of the data transmission.

According to the embodiments and examples described herein, a HARQ-ACK may be generated by the wireless device and transmitted on the uplink in response to a downlink data transmission.

According to the embodiments and examples described herein, the time domain pattern information may include HARQ-ACK transmission parameters. The HARQ-ACK transmission parameters may include the timing of the HARQ-ACK transmission, the uplink resources for carrying the HARQ-ACK, the carrier for the HARQ-ACK transmission and/or the number of repetitions of the uplink for carrying the HARQ-ACK. In one example, one HARQ-ACK bit may be generated for each downlink data transmission individually. In another example, one HARQ-ACK bit may be generated for a group of downlink data transmissions. In another example, one HARQ-ACK bit may be generated for each downlink data transmission individually, including its repetitions. In another example, one HARQ-ACK bit may be generated for a group of downlink data transmissions including their repetitions.

Modifications, additions, or omissions may be made to the method of FIG. 13. Additionally, one or more steps in the method of FIG. 13 may be performed in parallel or in any suitable order.

FIG. 14 illustrates an example wireless network, according to certain embodiments. The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations.

A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs.

As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 14, network node 160 includes processing circuitry 170, device readable medium 180, interface 190, auxiliary equipment 184, power source 186, power circuitry 187, and antenna 162. Although network node 160 illustrated in the example wireless network of FIG. 14 may represent a device that includes the illustrated combination of hardware components, other embodiments may comprise network nodes with different combinations of components.

It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node.

In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality.

For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162.

Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160.

For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 14 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IoT) standard. Examples of such machines or devices are sensors, metering devices such as power meters, industrial machinery, or home or personal appliances (e.g., refrigerators, televisions, etc.) personal wearables (e.g., watches, fitness trackers, etc.).

In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114.

Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips.

In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner.

In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected).

User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry.

Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

Although the subject matter described herein may be implemented in any appropriate type of system using any suitable components, the embodiments disclosed herein are described in relation to a wireless network, such as the example wireless network illustrated in FIG. 14. For simplicity, the wireless network of FIG. 14 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

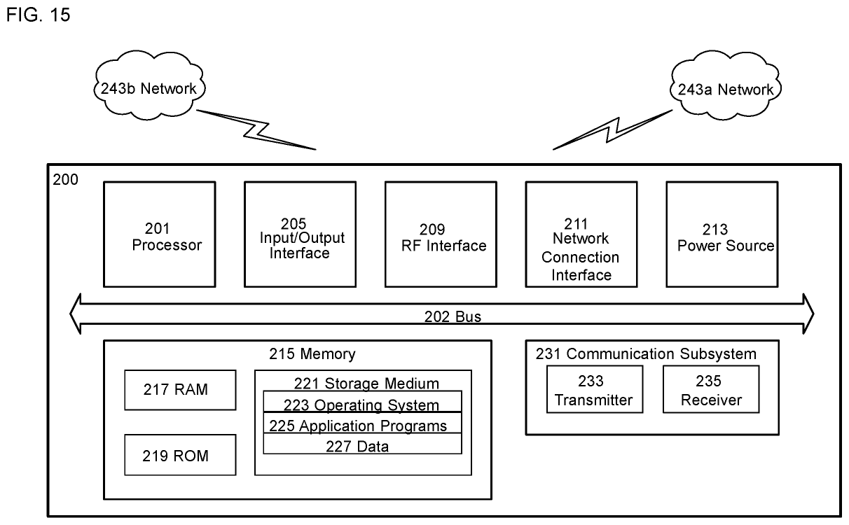

FIG. 15 illustrates an example user equipment, according to certain embodiments. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 15, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 15 is a UE, the components discussed herein are equally applicable to a WD, and vice-versa.

In FIG. 15, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 213, and/or any other component, or any combination thereof. Storage medium 221 includes operating system 223, application program 225, and data 227. In other embodiments, storage medium 221 may include other similar types of information. Certain UEs may use all the components shown in FIG. 15, or only a subset of the components. The level of integration between the components may vary from one UE to another UE. Further, certain UEs may contain multiple instances of a component, such as multiple processors, memories, transceivers, transmitters, receivers, etc.

In FIG. 15, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205.

An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof.

UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 15, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory.

Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 15, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

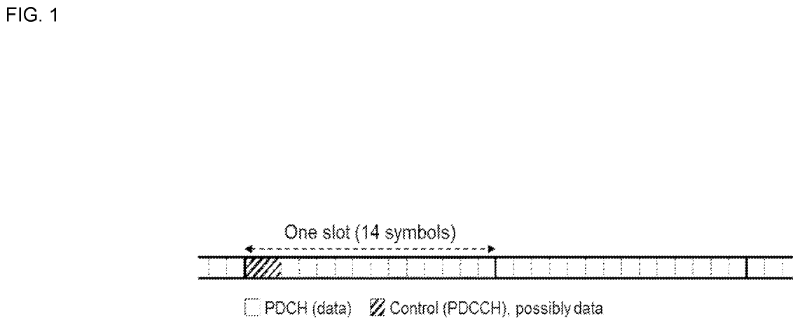

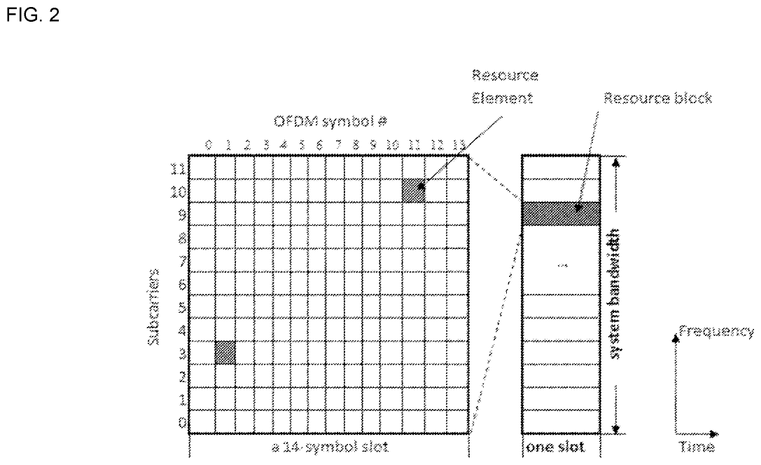

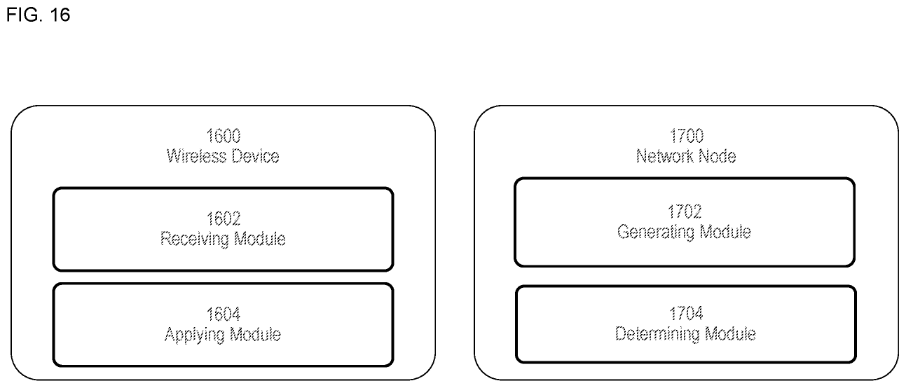

FIG. 16 illustrates a schematic block diagram of two apparatuses in a wireless network (for example, the wireless network illustrated in FIG. 14). The apparatuses include a wireless device and a network node (e.g., wireless device 110 and network node 160 illustrated in FIG. 14). Apparatuses 1600 and 1700 are operable to carry out the example methods described with reference to FIGS. 1-13 and possibly any other processes or methods disclosed herein. It is also to be understood that the methods of FIGS. 12 and 13 are not necessarily carried out solely by apparatuses 1600 and/or 1700. At least some operations of the method may be performed by one or more other entities.

Virtual apparatuses 1600 and 1700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

In some implementations, the processing circuitry may be used to cause receiving module 1602, applying module 1604, and any other suitable units of apparatus 1600 to perform corresponding functions according to one or more embodiments of the present disclosure. Similarly, the processing circuitry described above may be used to cause generating module 1702, transmitting module 1704, and any other suitable units of apparatus 1700 to perform corresponding functions according to one or more embodiments of the present disclosure.

As illustrated in FIG. 16, apparatus 1600 includes receiving module 1602 configured to receive a time domain pattern information indicating a time domain pattern for multiple TB transmission according to any of the embodiments and examples described herein. Applying module 1604 is configured to apply the time domain pattern information to multiple TB transmission according to any of the embodiments and examples described herein.

As illustrated in FIG. 16, apparatus 1700 includes generating module 1702 configured to generate a time domain pattern information indicating a time domain pattern for multiple TB transmission according to any of the embodiments and examples described herein. Transmitting module 1704 is configured to transmit the time domain pattern information to a wireless device according to any of the embodiments and examples described herein.

Some portions of the foregoing detailed description have been presented in terms of algorithms and symbolic representations of transactions on data bits within a computer memory. These algorithmic descriptions and representations are ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be appreciated, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to actions and processes of a computer system, or a similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present disclosure are not described with reference to any particular programming language. It should be appreciated that a variety of programming languages may be used to implement the teachings of embodiments as described herein.

Some embodiments may comprise an article of manufacture in which a non-transitory machine-readable medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In the foregoing detailed description, some embodiments have been described with reference to specific example embodiments thereof. It will be evident that various modifications may be made thereto without departing from the teachings as set forth in the following claims. The specification and drawings are, accordingly, to be regarded in an illustrative sense rather than a restrictive sense.

Throughout the description, some embodiments have been presented through flow diagrams. It should be appreciated that the order of transactions and transactions described in these flow diagrams are only intended for illustrative purposes and not intended as a limitation of the present disclosure. One having ordinary skill in the art would recognize that variations can be made to the flow diagrams without departing from the spirit and scope of the present disclosure as set forth in the following claims.

1. A method implemented by a network node in a communication network, the method comprising:
generating a time domain pattern information indicating a time domain pattern for a multiple transport block (TB) transmission; and
sending the time domain pattern information to a wireless device.

2.-18. (canceled)

19. A network node comprising processing circuitry operable to:
generate a time domain pattern information indicating a time domain pattern for a multiple transport block (TB) transmission; and
send the time domain pattern information to a wireless device.

20. The network node of claim 19, wherein the multiple transport block transmission is a semi-persistently scheduled data transmission, where each data transmission occurs periodically according to a previously provided configuration.

21. The network node of claim 20, wherein the semi-persistently scheduled data transmission is a semi-network node scheduled data transmission in downlink.

22. The network node of claim 20, wherein the semi-persistently scheduled data transmission is a configured grant data transmission in uplink.

23. The network node of claim 20, wherein the time domain pattern information includes a bitmap to indicate the time domain pattern for the semi-persistently scheduled data transmission, where one bit in the bitmap corresponds to one transmission time unit in the data transmission.

24. The network node of claim 23, wherein the bitmap has the same length as the period of the data transmission, where each bit in the bitmap corresponds to each transmission time unit in the period of the data transmission.

25. The network node of claim 23, wherein the bitmap is shorter than the period of the data transmission, where the bitmap of N_{bitmap} bits is applied to the first N_{bitmap} transmission time units in a given period, and no data transmission in the remaining transmission time units in the given period.

26. The network node of claim 20, wherein the time domain pattern information includes the period of the semi-persistent data transmission.

27. The network node of claim 20, wherein the data transmission is transmitted with repetition, and the time domain pattern information includes the number of repetitions of the data transmission.

28. The network node of claim 27, wherein the repetition is performed for each data transmission in consecutive transmission time units.

29. The network node of claim 27, wherein the repetition is performed across different periods of the data transmission.

30. The network node of claim 20, wherein a hybrid automatic repeat request (HARQ) acknowledgement-(ACK) is generated by the wireless device and transmitted on the uplink in response to a downlink data transmission, and the time domain pattern information includes HARQ-ACK transmission parameters.

31. The network node of claim 30, wherein the HARQ-ACK transmission parameters include the timing of the HARQ-ACK transmission, the uplink resources for carrying the HARQ-ACK, the carrier for the HARQ-ACK transmission or the number of repetitions of the uplink for carrying the HARQ-ACK.

32. The network node of claim 30, wherein one HARQ-ACK bit is generated for each downlink data transmission individually.

33. The network node of claim 30, wherein one HARQ-ACK bit is generated for a group of downlink data transmissions.

34. The network node of claim 30 wherein one HARQ-ACK bit is generated for each downlink data transmission individually, including its repetitions.

35. The network node of claim 30, wherein one HARQ-ACK bit is generated for a group of downlink data transmissions including their repetitions.

36. The network node of claim 23, wherein the transmission time unit is a slot, part of a slot or a number of slots.

37. A method implemented by a wireless device in a communication network, the method comprising:
receiving a time domain pattern information indicating a time domain pattern for multiple transport block (TB) transmission; and
applying the time domain pattern information to a multiple TB transmission.

38.-54. (canceled)

55. A wireless device comprising processing circuitry operable to:
receive a time domain pattern information indicating a time domain pattern for multiple transport block (TB) transmission: and
apply the time domain pattern information to a multiple TB transmission.

56. The wireless device of claim 55, wherein the multiple transport block transmission is a semi-persistently scheduled data transmission, where each data transmission occurs periodically according to a previously provided configuration.

57. The wireless device of claim 56, wherein the semi-persistently scheduled data transmission is a semi-persistently scheduled data transmission in downlink.

58. The wireless device of claim 56, wherein the semi-persistently scheduled data transmission is a configured grant data transmission in uplink.

59. The wireless device of claim 56, wherein the time domain pattern information includes a bitmap to indicate the time domain pattern for the semi-persistently scheduled data transmission, where one bit in the bitmap corresponds to one transmission time unit in the data transmission.

60. The wireless device of claim 59, wherein the bitmap has the same length as the period of the data transmission, where each bit in the bitmap corresponds to each transmission time unit in the period of the data transmission.

61.-72. (canceled)
